(19) United States
(12) Patent Application Publication
(10) Pub. No.: US 2014/0223815 A1
(43) Pub. Date: Aug. 14, 2014

(54) PLANT DEVELOP DEVICE AND PLANT DEVELOP WALL INCLUDING THE SAME

(71) Applicant: ELE-GARDEN LANDSCAPE CONSTRUCTION CO.,, Taichung City (TW)

(72) Inventors: Kong-Iong KUO, Taichung City (TW); Wei-Hsun CHANG, Taichung City (TW)

(73) Assignee: ELE-GARDEN LANDSCAPE CONSTRUCTION CO., Taichung City (TW)

(21) Appl. No.: 13/765,834

(22) Filed: Feb. 13, 2013

(51) Int. Cl. A01G 9/02

(52) U.S. Cl. CPC A01G 9/02; A01G 9/025
USPC 47/82; 47/79

(57) ABSTRACT

A plant develop device includes a tubular structure, a water supply device, and a soil package. The tubular structure forms a plurality of growth holes, and a plurality of water conservation grooves are formed at a bottom of an internal surface of the tubular structure. Growth medium is wrapped by the soil package therein, and a through hole corresponding to one of the growth hole is formed on a surface of the soil package. The plant develop wall of the present invention includes the plant develop device, a rack, and a positioning ring which is used to fix the tubular structure on the rack. Thereby, the present invention can provides sufficient room for plant growing, improved fixation, and water regulation.

### BACKGROUND OF THE INVENTION

1. Field of the Invention

The present invention relates to a device for growing plants, more particularly to a device which is suitable for growing plants in a large amount.

2. Description of the Prior Art

A conventional plant develop wall is composed of a plurality of case-shaped containers which are connected to each other or is a system of vegetation bags.

However, the conventional plant develop wall mentioned above has some problems. First, the plant is restricted by the small space of the containers so that roots of the plants are difficult to extend and is possibly dead. Second, the plants may fall. Third, roots of plants may jam the draining holes so that plants can not acquire water. Fourth, roots of plants may jam the draining holes so that water in the container is unable to be discharged and that roots may rot.

Besides, the system of vegetation bags must be installed in bigger room and requires steel structure. Thereby, cost is difficult to be reduced.

### SUMMARY OF THE INVENTION

The main object of the present invention is to provide a plant develop device and a plant develop wall including the plant develop device to provide sufficient growing room, better fixation, humidity regulation, water recycling, infection preventing, and angle adjustment.

To achieve the above and other objects, a plant develop device of the present invention includes a tubular structure, a water supply device, and a soil package.

The tubular structure defines a receiving room enclosed therein and forms a plurality of growth holes and a draining hole. Each growth hole and the draining hole communicate with the receiving room respectively. The tubular structure has an internal surface and an external surface wherein the internal surface includes a top and a bottom. A plurality of water conservation grooves are formed on the bottom of the internal surface of the tubular structure. The water supply device forms a plurality of outlet holes communicating with the receiving room. The soil package is disposed in the receiving room, and growth medium is wrapped by the soil package. The soil package forms at least one through hole on its surface, and the through hole corresponds to one of the growth holes.

To achieve the above and other objects, a plant develop wall of the present invention includes the plant develop device, a rack, and a positioning ring. The positioning ring is sleeved around the external surface of the tubular structure, and two ends of the positioning ring are fixed to the rack.

Thereby, the plant develop device and the plant develop wall of the present invention provide sufficient space for growing, better fixation, humidity regulation, water recycling, infection preventing, and angle adjustment.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a breakdown drawing showing a first embodiment of the present invention;

FIG. 3 is a cross-section drawing showing a first embodiment of the present invention;

FIG. 4 is a perspective drawing showing a first embodiment of the present invention;

FIG. 5 is an illustration of routes of water flowing of the present invention;

FIG. 6 is an illustration showing two connected tube units of the present invention;

FIG. 7 is a perspective drawing showing a second embodiment of the present invention.

### DETAILED DESCRIPTION OF THE PREFERRED EMBODIMENTS

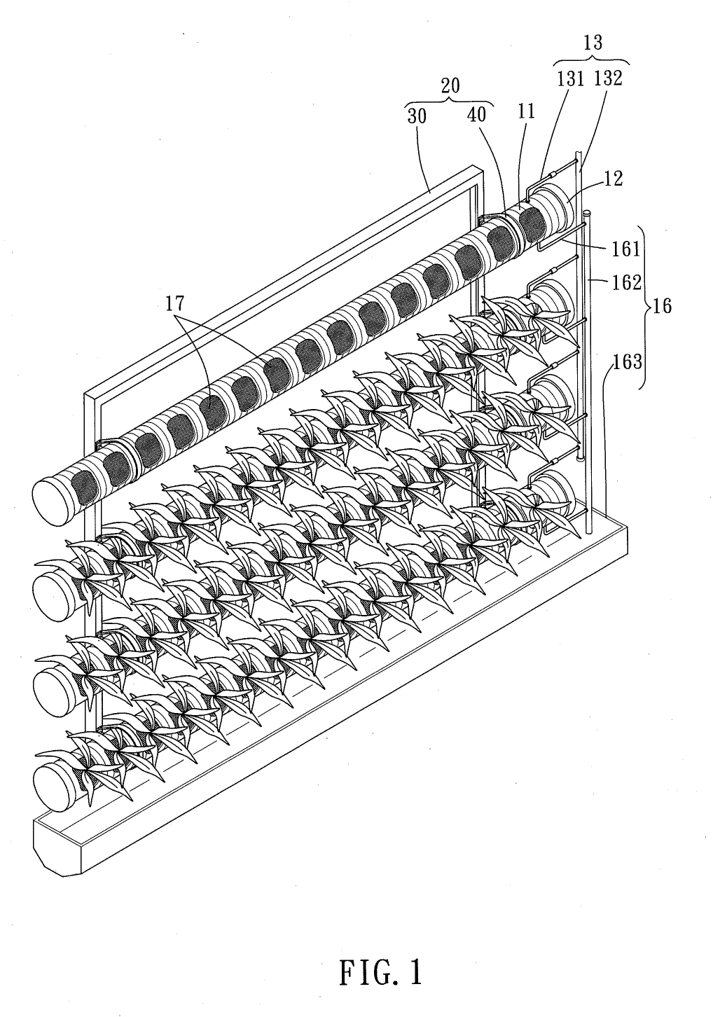

Please refer to FIG. 1 to FIG. 4 for a preferred embodiment of the present invention. The plant develop device of the present invention includes a tubular structure 11, two covers 12, a water supply device 13, a first water-imbibing element 14, a second water-imbibing element 15, a water discharging device 16, and a soil package 17.

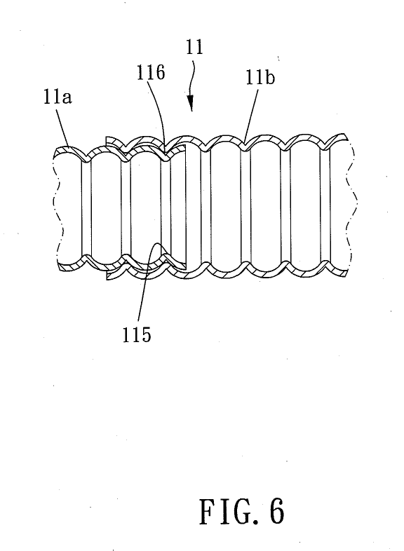

The tubular structure 11 defines a receiving room enclosed therein and forms a plurality of growth holes 112 and a draining hole 113. Each growth hole 112 and the draining hole 113 communicate with the receiving room respectively. More preferably, the growth holes 112 are spacedly arranged at a same side of the tubular structure. The tubular structure 11 includes an internal surface and an external surface wherein the internal surface has a top and a bottom. A plurality of water conservation grooves 114 are formed on the bottom of the internal surface of the tubular structure 11. More specifically, a plurality of annular protrusions 115 are formed on the internal surface of the tubular structure 11, and a groove is formed between any two adjacent annular protrusions 115 wherein part of each groove located at the bottom of the internal surface of the tubular structure 11 forms one of the water conservation grooves 114. Preferably, each annular protrusion 115 and the tubular structure 11 are co-axial. Even more, the external surface of the tubular structure 11 can further form a plurality of annular groove 116, and the annular grooves 116 correspond to the annular protrusions 115. In the major embodiment, the tubular structure 11 is simply tube-shaped, as shown in FIG. 1. However, the tubular structure 11 can alternatively include a plurality of tube units 11a, 11b. Part of the annular protrusions 115 at an end of each tube unit 11a is engaged with part of the annular grooves 116 at an end of an other tube unit 11b. Thereby, the tube units 11a, 11b are connected together to form the tubular structure 11, as shown in FIG. 6. The tubular structure 11 has a first end and a second end, and an opening is formed at each of the first end and the second end wherein each opening communicates with the receiving room 111. Optionally, the first end and the second end do not form the openings and are closed to form blind ends. On the other hand, the tubular structure can be made of but not be limited to HDPE or PE.

The two covers 12 cover the first end and the second end of the tubular structure 11. Preferably, each cover 12 has an inner surface, and an adhesive layer is disposed between the inner surfaces of the covers 12 and the external surface of the tubular structure at the first end or the second end so that the cover 12 can be adhesively fixed to the first end and the second end of the tubular structure 11. In other possible embodiments, the inner surface of each cover 12 can form one or more annular protrusions to be engaged with the annular grooves 116 on the external surface of the tubular structure 11 at the first end or the second end.

The water supply device 13 includes a water supply pipe 131 and a first connecting pipe 132. The water supply pipe 131 is inserted through the tubular structure 11 and reaches the receiving room 111, and then the water supply pipe 131 further extends along a longitudinal direction of the tubular structure 11 to the top of the internal surface of the tubular structure 11. The water supply pipe 131 forms a plurality of outlet holes (not shown in figures) communicating with the receiving room 111. The water supply pipe 131 is connected with the first connecting pipe 132, and the first connecting pipe 132 is adapted for connecting with a water source.

The first water-imbibing element 14 wraps around the water supply pipe 131. More specifically, the first water-imbibing element wraps around part of the water supply pipe 131 located in the receiving room 111. Preferably, the first water-imbibing element 14 is a cloth or is made of material which is water-absorbable, such as non-woven fabric.

The second water-imbibing element 15 is disposed at the bottom of the internal surface of the tubular structure 11. Preferably, the second water-imbibing element 15 is a cloth or is made of material which is water-absorbable, such as non-woven fabric.

The water discharging device 16 includes a discharging pipe 161, a second connecting pipe 162, and a water collecting device 163. An end of the discharging pipe 161 communicates with the draining hole 113, and an opposite end of the discharging pipe 161 is connected with the second connecting pipe 162. Water drained from the discharging pipe 161 can be guided to the water collecting device 163 by the second connecting pipe 162.

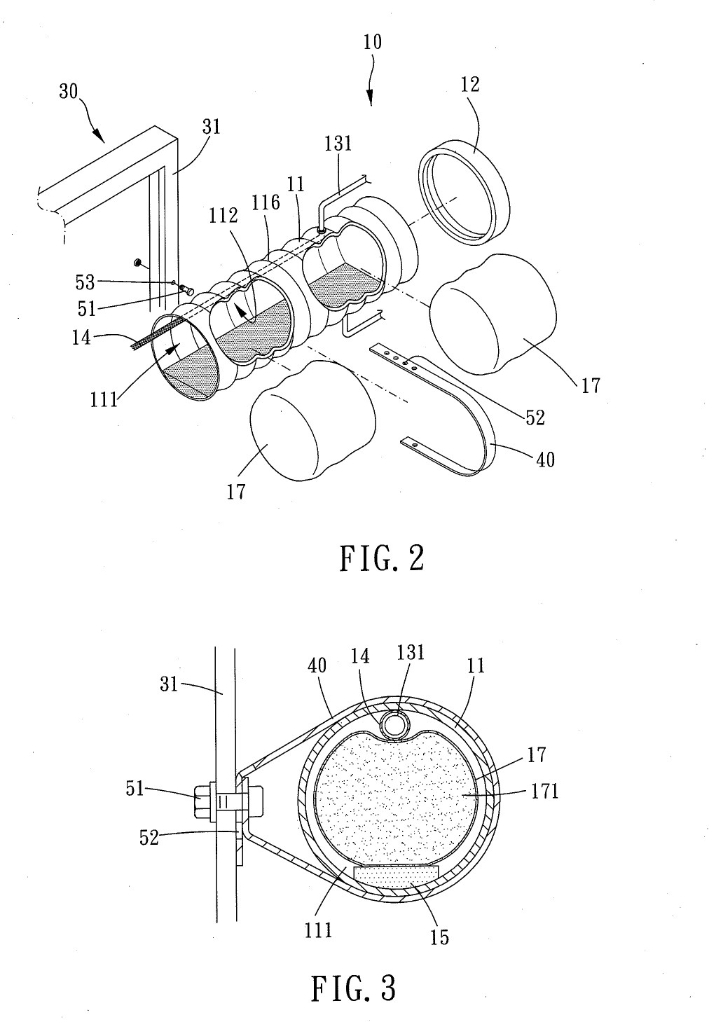

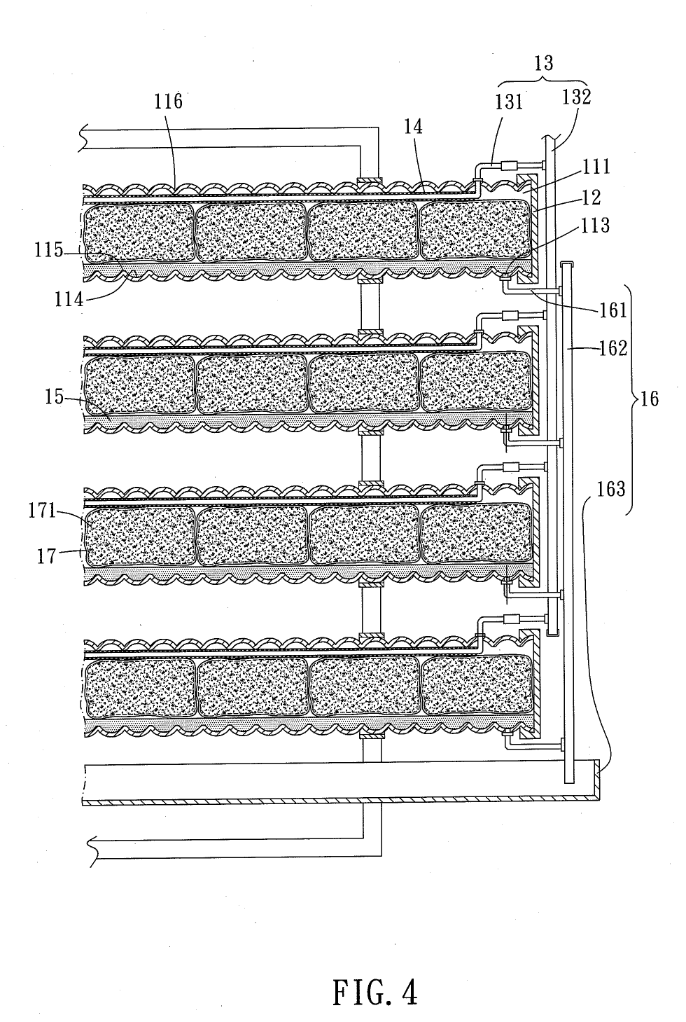

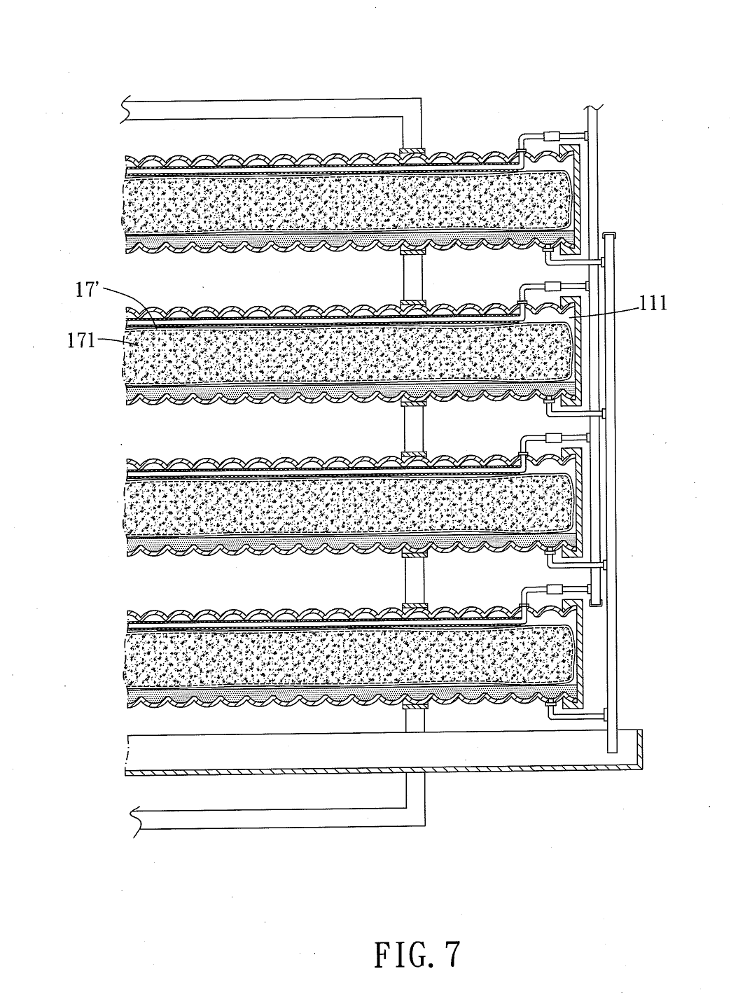

The soil package 17 is disposed in the receiving room 111 upon the second water-imbibing element 15. Growth medium 171 is wrapped by the soil package 17 therein. In the major embodiment, a plurality of soil packages 17 are disposed in the receiving room 111, as shown in FIGS. 2 and 4. Each soil package 17 is adapted for a plant being developed in the growth medium 171. Each soil package 17 forms a through hole and a plurality of tiny pores (not shown in figures) on its surface, and the through hole corresponds to one of the growth holes 112. A position where the plant is cultivated corresponds to the through hole. Thereby, the plant grows and penetrates through the through hole and the growth hole to extend outside the tubular structure 11, as shown in FIG. 1. In addition, the tiny pores are adapted for fluid and air entering or leaving the soil package 17 for ventilation. In other possible embodiments, a single soil package 17′ in an elongated shape is disposed in the receiving room 111, and a plurality of through holes are formed on a surface of the soil package 17′. The soil package 17′ is adapted for a plurality of plants to be cultivated in the growth medium 171. Each plant correspond to one of the through holes, and each through hole corresponds to one of the growth holes 112, as shown in FIG. 7. Preferably, the soil package 17, 17′ is made of shading net, non-woven fabric, or other material which is ventilating and water-permeable.

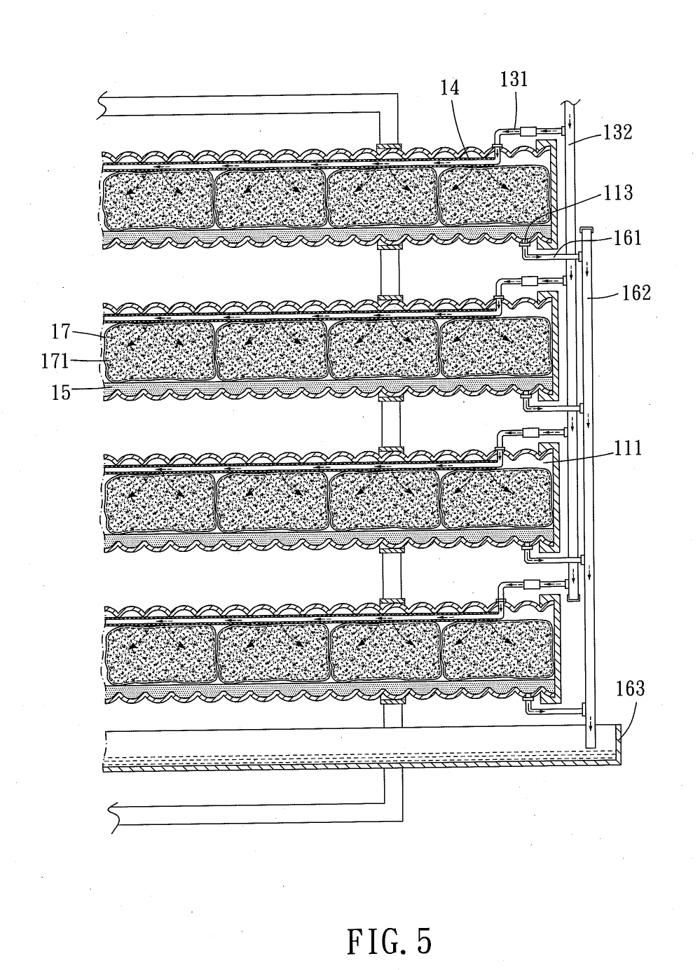

Please refer to FIG. 5, water from outer source enters the water supply pipe 131 via the first connecting pipe 132, and then water further flows out from the outlet holes of the water supply pipe 131. Thereafter, water flowing out from the outlet holes is absorbed by the first water-imbibing element 14. Due to capillary action and evapotranspiration, water is spread over the whole first water-imbibing element 14. When the first water-imbibing element 14 has absorbed water in a maximum amount, water may seep out from surface of the first water-imbibing element 14 and is coagulated into drops. Under the gravity, the drops are dropped down to surface of the soil package 17 downward. And then, due to capillary action and evapotranspiration, water drops are spread over the soil package and are seeped into the growth medium 171. When the growth medium 171 has absorbed water in a maximum amount, excess water may drop downward from surface of the soil package 17, and water dropping from the soil package 17 may be absorbed by the second water-imbibing element 15 for recycling and re-using. Besides, if water in the growth medium 171 is absorbed by the plant, the growth medium 171 may imbibe water from the second water-imbibing element 15. On the other hand, part of water may flow into the discharging pipe 161 via the draining hole 113, and water is further discharged to the water collecting device 163 via the second connecting pipe 162.

In addition, when the first water-imbibing element 14, the soil package 17, and the growth medium 171 are all saturated with water, part of water may evaporate into the receiving room, and the evaporated water may adhere to the internal surface of the tubular structure 11 to coagulate to drops. The drops further moves into the water conservation grooves 114, and water in the water conservation grooves 114 is absorbed by the second water-imbibing element 15 for recycling.

Please refer to FIGS. 1 to 4, in the major embodiment, the plant develop wall 20 of the present invention includes the plant develop device 10, a rack 30, and a positioning ring 40.

The rack 30 has a pillar 31, and the positioning ring 40 is sleeved around the external surface of the tubular structure 11. Two ends of the positioning ring 40 along a radial direction are fixed to the pillar 31. Thereby, the tubular structure 11 can be positioned and fixed to the pillar 31 tightly. Preferably, the plant develop wall 20 further includes an adjusting mechanism. The adjusting mechanism includes a screwing element 51, a plurality of first through holes 52, and a second through hole 53. The first through holes 52 are formed on one of the pillar 31 and the positioning ring 40, and the second through hole 53 is formed on the other one of the pillar 31 and the positioning ring 40. Please refer to FIG. 2, in this embodiment, the first through holes 52 are formed on the positioning ring 40, and the second through hole 53 is formed on the pillar 31. The screwing element 51 is inserted through one of the first through hole 52 and is further fixed to the second through hole 53. Thereby, tubular structure 11 with different diameter can be positioned to the pillar tightly.

Please refer to FIG. 1, the plant develop wall 20 can include a plurality of plant develop devices which are spacedly arranged along a longitudinal direction of the pillar. The first connecting pipe 132 is connected with each water supply pipe 131 to supply water to each water supply pipe 132 at the same time. Also, the second connecting pipe 162 is connected with each discharging pipe 131 to discharge water from each discharging pipe 161 to the water collecting device 163.

Thereby, the tubular structure 11 provides sufficient room for root of plant to grow, better fixation, and water conservation so as to facilitate growth of root and to prevent plant from falling. Besides, the tubular structure 11 can be rotated to adjust position of the growth hole 112 so that angle to the sun of the plant and angle of displaying can be adjusted. Specifically, when the tubular structure 11 includes a plurality of tube units 11a, 11b, angles of the tube units 11a, 11b can be adjusted respectively for developing different kinds of plants.

Furthermore, the first water-imbibing element 14 can prevent the outlet holes of the water supply pipe 131 from jammed by plants, and the second water-imbibing element 15 can prevent the draining holes 113 from jammed y plants. The first water-imbibing element 14 is able to provide water drops to the soil package 17, 17′ in a fashion similar to dewing. The first and the second water-imbibing elements 14, 15 facilitate water recycling, and the second water-imbibing element 15 is able to absorb water from the growth medium 171 or to reversely provide water to the growth medium 171. Thus, humidity in the receiving room 111 can be finely regulated to prevent water wasting but to supply sufficient water to plants.

Besides, the plant develop wall 20 can include a plurality of plant develop devices 10 having independent water supplying and recycling systems to prevent infection between the plant develop devices 10. Also, in some possible embodiments, the first through holes 52 can communicate with each other. Thus, when slightly loosened, the screwing element 51 is slidable in the first through holes 52 so that the tubular structure 11 can be rotated easily for angle adjusting. After adjustment, the tubular structure 11 can be quickly positioned by the screwing element 51.

What is claimed is:

1. A plant develop device, including:
a tubular structure, enclosing a receiving room, the tubular structure forming a plurality of growth holes and a draining hole, each growth hole communicating with the receiving room, the tubular structure having an internal surface and an external surface, the internal surface including a top and a bottom wherein a plurality of water conservation grooves are formed on the bottom thereof;
a water supply device, forming a plurality of outlet holes communicating with the receiving room;
a soil package, disposed in the receiving room, growth medium being wrapped by the soil package therein, the soil package forming at least one through hole on surface thereof, the through hole corresponding to one of the growth holes.

2. The plant develop device of claim 1, further including two covers, the tubular structure having a first end and a second end, the two covers covering the first end and the second end of the tubular structure respectively.

3. The plant develop device of claim 2, wherein each cover has an inner surface, an adhesive layer is disposed between the inner surfaces of the covers and the external surface of the tubular structure at the first end or the second end so that the covers are fixed to the first end or the second end of the tubular structure.

4. The plant develop device of claim 1, further including a first water-imbibing element, the water supply device including a water supply pipe, the water supply pipe extending into the receiving room and being located at the top of the internal surface of the tubular structure, the water supply pipe forming the outlet holes, the first water-imbibing element wrapping over the water supply pipe.

5. The plant develop device of claim 1, further including a second water-imbibing element disposed at the bottom of the internal surface of the tubular structure, the soil package being disposed upon the second water-imbibing element.

6. The plant develop device of claim 1, wherein the tubular structure includes a plurality of tube units, a plurality of annular grooves are formed on an outer surface of each tube unit, a plurality of annular protrusions are formed on an inner surface of each tube unit, each annular groove is formed between any two adjacent annular protrusions, part of the each annular groove located at the bottom of the internal surface of the tubular structure forms one of the water conservation grooves, two adjacent tube units are connected by engagement between the annular protrusion of one of the two tube units and the annular groove of the other one of the two tube units.

7. The plant develop device of claim 1, further including a water discharging device, the water discharging device including a discharging pipe, an end of the discharging pipe communicating with the draining hole.

8. A plant develop wall, including a plant develop device of claim 1, further including a rack and a positioning ring, the positioning ring being sleeved around the external surface of the tubular structure, two ends of the positioning ring being fixed to the rack.

9. The plant develop wall of claim 8, wherein the rack has a pillar, the two ends of the positioning ring is fixed to the pillar.

10. The plant develop wall of claim 8, further including an adjusting mechanism, the adjusting mechanism including a screwing element, a plurality of first through holes, and a second through hole, the first through holes being formed on one of the rack and the positioning ring, the second through hole being formed on the other one of the rack and the positioning ring, the screwing element being inserted through one of the first through holes and then fixed to the second through hole.

11. The plant develop wall of claim 8, the plant develop device further including two covers, the tubular structure having a first end and a second end, the two covers covering the first end and the second end of the tubular structure respectively.

12. The plant develop wall of claim 9, wherein each cover has an inner surface, an adhesive layer is disposed between the inner surfaces of the covers and the external surface of the tubular structure at the first end or the second end so that the covers are fixed to the first end or the second end of the tubular structure.

13. The plant develop wall of claim 8, the plant develop device further including a first water-imbibing element, the water supply device including a water supply pipe, the water supply pipe extending into the receiving room and being located at the top of the internal surface of the tubular structure, the water supply pipe forming the outlet holes, the first water-imbibing element wrapping over the water supply pipe.

14. The plant develop wall of claim 8, the plant develop device further including a second water-imbibing element disposed at the bottom of the internal surface of the tubular structure, the soil package being disposed upon the second water-imbibing element.

15. The plant develop wall of claim 8, wherein the tubular structure includes a plurality of tube units, a plurality of annular grooves are formed on an outer surface of each tube unit, a plurality of annular protrusions are formed on an inner surface of each tube unit, each annular groove is formed between any two adjacent annular protrusions, part of the each annular groove located at the bottom of the internal surface of the tubular structure forms one of the water conservation grooves, two adjacent tube units are connected by engagement between the annular protrusion of one of the two tube units and the annular groove of the other one of the two tube units.

16. The plant develop wall of claim 8, the plant develop device further including a water discharging device, the water discharging device including a discharging pipe, an end of the discharging pipe communicating with the draining hole.
